(19) United States
(12) Patent Application Publication
(10) Pub. No.: US 2007/0281776 A1
(43) Pub. Date: Dec. 6, 2007

(54) Display type slot machine

(76) Inventor: Haruo Inoue, Tokyo (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/637,795

(22) Filed: Dec. 13, 2006

(30) Foreign Application Priority Data
May 16, 2006 (JP) 2006-136862

(51) Int. Cl. A63F 13/00

(52) U.S. Cl. 463/20

(57) ABSTRACT

In a display type slot machine, a background image operated means is generated so that a three-dimensional image which contains a 1st mechanical element in a background image may be displayed, on the other hand, a reel image generating means contains a 2^{nd} mechanical element at the end part of a reel, and this 2nd mechanical element carries out variable displaying receiving the power of a 1st mechanically element of said background image. When a game is performed, for the visual perception of a player, it gives a mechanical and a three-dimensional real feeling to variable displaying of a reel displayed on a display, and it is giving an image which a reel rotates actually via a means of power transfer of a background image.

### REFERENCE TO FOREIGN PATENT APPLICATIONS

This application is based on Japanese Patent Application 2006-136862 filed on May 16, 2006, upon which priority is claimed.

### BACKGROUND OF THE INVENTION

1. Field of the Invention

The present invention relates to a display type slot machine (what is built in game machines, such as pachinko machines, is included.). In particular, it is related with art of carrying out variable displaying of two or more imitated virtual reels which contain a symbol with a background image, on a display (a solid type display or a flat type display).

2. Description of the Prior Art

Japanese patent document JP, 8-10381,A discloses a display intended to increase visual interest or attraction by relating mutually a display of virtual reels and a display of background which produces a sport combative (for example, professional wrestling), according to a state of a virtual reel.

As illustrated by FIG. 12, Japanese patent document JP, 8-10381,A discloses a display type slot machine in which the control information or signal generating means of a reel which generates a rotate information or signal and a stop information or signal of two or more reels, the image control part 2 which has a reel image generating means 2a and a background image generating means 2b, and the display control part 3 displayed on a display D combining a reel image signal “a” and a signal of a background image “b”.

In addition Japanese patent document JP, 8-10381,A discloses a display type slot machine in which a reel type slot machine comprises:

a control information (signal) generating means 1 of a reel state which generates a rotary variation and a stop information of a reel,
an image control part 2 having a reel image generating means 2a to which variable displaying of the reel containing a symbol is carried out and a background image generating means 2b to which it relates with variable displaying of a reel and variable displaying of a background image is carried out, and
a display control part 3 displayed on a display D combining a reel image signal “a” from this image control part 2 and the signal of a background image b.

FIGS. 13 (a), (b), (c) indicate an example in which a background image BG carries out variable displaying corresponding to variable displaying of reel R1, R2, and R3 of Japanese patent document JP, 8-10381,A.

In FIG. 13 (a), a number “7” displayed on the display D means a left reel R1. Therefore, a number “1” means a right reel R3. And a number “6” means a central reel R2.

### FIG. 13 (b) indicates that a background image BG which produces a sport combative (for example, professional wrestling) is also changed together, when these reels R1, R2, and R3 are changed (during a game).

### FIG. 13 (c) indicates that a background image BG was also stopped, when all reels R1, R2, and R3 stop (the end of a game).

### As a background image BG of Japanese patent document JP, 8-10381,A seasons game feeling with performance effects about a sport combative to vision of a player, there is visual interesting.

However, there are the following problems with the display device of JP, 8-10381,A. A background image BG does not contain a mechanical element (power transmission mechanism). And since it seems to variably display a reel that a symbol is moving in the up-and-down direction, it only seems that reel R1, R2, and R3 are carrying out the rotary variation. Therefore, a mechanical real feeling cannot be given to variable displaying of a reel.

Japanese patent document JP, 7-112052, A is an example of a virtual reel which an applicant filed. Although Japanese patent document JP, 7-112052, A has a statement about a mode of a display frame of a reel, it is unstated about a mode of a reel image or a background image.

### SUMMARY OF THE INVENTION

An object of the present invention is as follow.

### In a display type slot machine, when a player starts a game,

it is an object to give the player a visual perception of a mechanical element and a three-dimensional real feeling, or a pattern element to variable displaying of a reel displayed on a display (it contains, also when only a symbol carries out a rotary variation), and to give an image which a reel rotates actually via a means of power transfer of a background image.

Other objects of the present invention are to emphasize a background image and to give much more real feeling to variable displaying of a reel (rotation image).

The display type slot machine assembly having

a control information generating means of a reel state which generates a rotary variation stop information of a reel and a stop information of a reel based on information of a storage parts store,
an image control part which has a reel image generating means which carries out variable displaying of the reel which contains a symbol based on information from said control information generating means and a background image generating means which relates with variable displaying of a reel and carries out variable displaying of the background image and a display control part displayed on a display combining a reel image signal and a signal of a background image from said image control part, further comprising:
said background image generating means is generated so that a three dimensional image which contains a 1st mechanically element in said background image may be displayed and said reel image generating means contains a 2nd mechanically element in an end display of said reel, and it generates so that this 2nd mechanically element may carry out variable displaying in response to power of a 1st mechanically element of said background image.

And the display type slot machine assembly having

a control information generating means of a reel state which generates a rotary variation information of a reel and a stop information of a reel based on information of a storage parts store,
an image control part which has a reel image generating means which carries out variable displaying of the reel which contains a symbol based on information from said control information generating means and a background image generating means which relates with variable displaying of a reel and carries out variable displaying of the background image and a display control part displayed on a display combining a reel image signal and a signal of a background image from said image control part, further comprising:
said background image generating means is generated so that a three dimensional image which contains said mechanically element in said background image may be displayed and said reel image generating means is generated so that a pattern element may be included in said reel and this pattern element may carry out variable displaying to said reel in response to power of a mechanically element of said background image.

A “display type” is a solid type display means for example, a cathode-ray tube type, a flat type display means (a liquid crystal display type and an organic electroluminescence indication type) and a similar thing is also included. Therefore, a reel type display means and a wheel type display means which rotate machinelike are not included.

The present invention is understood to encompass embodiments which include all or only a portion of the above objects, features and advantages which, unless recited in claims defining the invention, are understood not to limit interpretation of such claims.

### BRIEF DESCRIPTION OF THE DRAWINGS

The above, and other objects, features and advantages of the present invention will become apparent from the following description read in conjunction with the accompanying drawings, in which like reference numerals designate the same elements. It is to be expressly understood, however, that the drawings are for the purpose of illustration and description only, and are not intended as a definition of the limits of the present invention. In the drawings,

FIG. 1 is a control block diagram view of a slot machine embodying the present invention.

FIG. 2 is an enlarged exploded fragmentary view of a data constitution of a storage parts store.

FIG. 3 is an enlarged fragmentary view of an example of a display on vision of each data.

FIG. 4 is an information figure view showing an example of combination of an image.

FIG. 5 is an information figure view showing other examples of combination of an image.

FIG. 6 is an enlarged fragmentary viewing an example of an initial screen.

FIG. 7 is an enlarged fragmentary viewing an example of variably displaying at the time of a start.

FIG. 8 is an enlarged fragmentary viewing an example of emphasis image 1.

FIG. 9 is an enlarged fragmentary viewing an example of emphasis image 2.

FIG. 10 is a flow chart of the present invention.

FIG. 11 is an enlarged fragmentary viewing an example of appearance composition of the present invention.

FIG. 12 is a control block diagram, view showing an example of a prior art slot machine; and

FIG. 13 (a), (b) and (c) are each information figure, view showing an example of a produced display on a prior art display.

### DESCRIPTION OF THE PREFERRED EMBODIMENTS

In explanation of one embodiment of this invention, for convenience, the same composition as JP, 8-10381,A (the prior art) attaches the same numerals.

A new matter of the present invention is mainly explained, and details of the prior art are omitted.

A “reel” means a “virtual reel”.

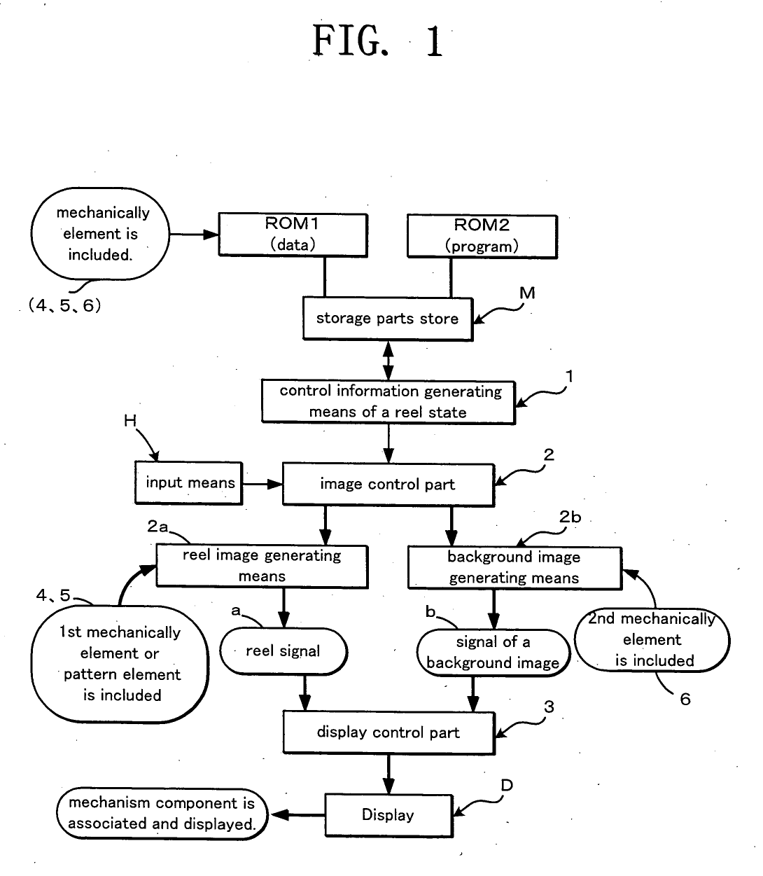

A basic block diagram 1 of a slot machine is a block diagram showing composition of a display type slot machine. In FIG. 1, M is the storage parts store. This storage parts store M contains ROM 1 which stored data, and ROM 2 which stored a sequence program. H is a control means as an example of an input means. For example, control means H are two or more switch buttons, a lever handle, various kinds of sensors, etc.

1 is a control information generating means for a reel state which generates a rotary variation of a reel and stop information of a reel based on information on an input means and a storage parts store M (ROM1 and ROM2).

2 is an image control part which has a reel image generating means 2a which carries out variable displaying of the reel containing a symbol and a background image generating means 2b which relates with variable displaying of a reel and carries out variable displaying of the background image, based on information from said control information generating means 1.

3 is a display control part displayed on a predetermined field of display D combining a reel image signal “a” from said image control part 2 and a background image signal “b”.

On this embodiment, a flat display means may be used for a display D. D is a display which displays a reel image B1 containing a symbol A1 outputted from said display control part 3, and background image C1.

A display D displays a variable image of a reel image B1, a static image of a reel image B1, a variable image of a background image C1 , a static image of a background image C1, and etc. That is, a still image and a dynamic image are described by a display D, respectively.

A display type slot machine of the present invention mainly differs in the following point to the invention of Japanese patent document JP, 8-10381, A.

### A background image generating means 2b generates a display of a three dimensional image which contains a 1st mechanical element in background image C1.

A reel image generating means 2a contains a 2nd mechanical element in an end portion of a reel image B1, and generates an image that this 2nd mechanical element may carry out variable displaying receive power of a 1st mechanical element of said background image.

And desirably, said background image C1 contains a dynamic image as which a power transmission mechanism was emphasized. Said reel image B1 contains a pattern element 4.

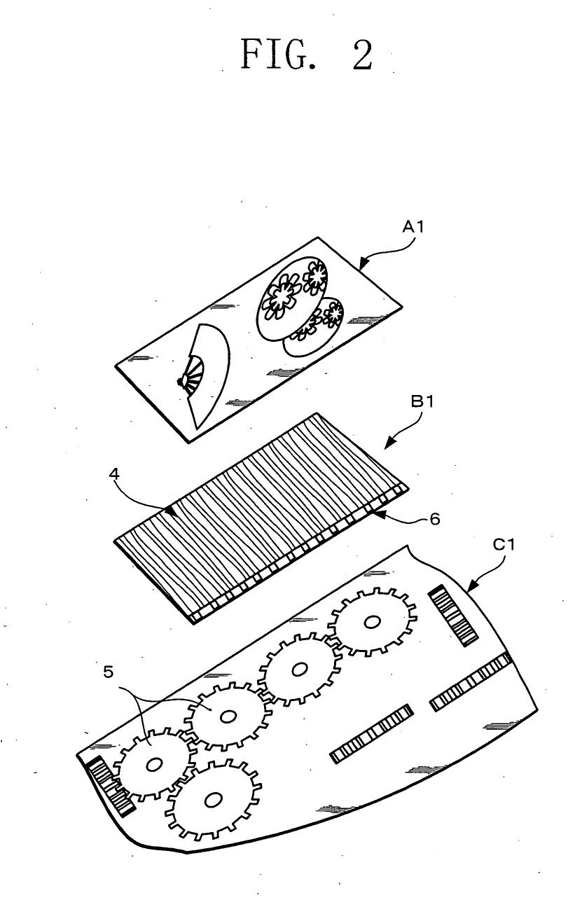

FIG. 2 is schematically showing a data constitution of storage parts store M.

### A1 is a symbol data containing a symbol which does not attach a number.

### B1 is a reel data containing pattern component 4 and a mechanical element 6.

### C1 containing a mechanical element 5 is a background data.

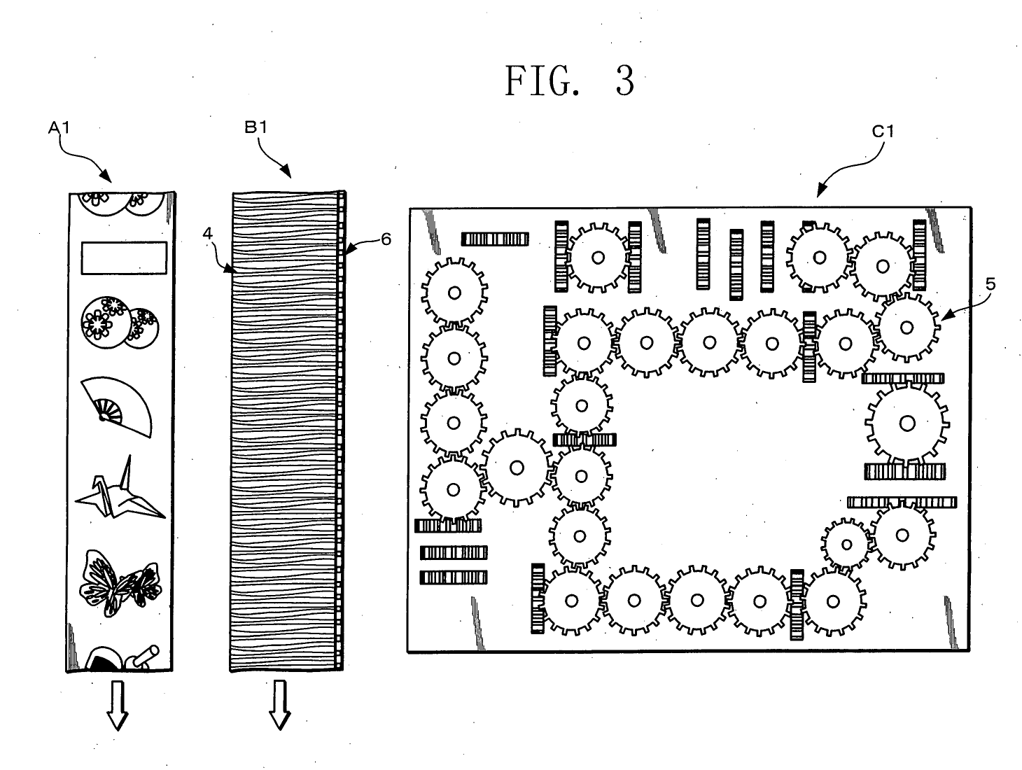

FIG. 3 shows each easy display example of a symbol data (symbol) A1, a reel data (reel image) B1, and background data (background image) C1.

### That is, FIG. 3 shows a static a symbol, a static reel image, and a static background image which are displayed on a display D, respectively.

Here, a symbol data A1 and a symbol A1 are made into the same numerals for convenience of explanation. A reel image B1 is also the same as a reel data B1.

### Therefore, a background image C1 is also the same as a background data C1.

A shape information, color information, and pattern information of a symbol are included in a symbol data A1 as shown in FIGS. 2 and 3.

### The following are contained in a reel data B1,

a shape information of a reel body,
a color information of a reel body,
a pattern information displayed on a surface of a reel body (for example, a wood-grain pattern, a lateral pattern, an opening pattern, etc.),
a shape information of a 2nd mechanical element (for example, a gear part, a belt with a gear, etc.) displayed on an one end part (the right end) of a reel body by longitudinal,
a color information of a 2nd mechanical element,
a pattern information of a 2nd mechanical element.

The 2nd mechanical element of the embodiment is the information on a portion that power is received.

### In this embodiment, it is each information on the shape, color, and a pattern of a gear part.

Further, the following is contained in background data C1,

a shape information of a three dimensional image containing 1st mechanical element 5,
a color information of a 1st mechanical element and
a shape information of a 1st mechanical element.

### In the embodiment, it is each information on the shape, color, and a pattern of a gear transmission mechanism as an example of a power transmission mechanism.

A color information and a pattern information 4 certainly have a shape information. For example, when a color information of a reel body is colorless (a non-pattern, a single color), a reel body has certainly a shape information (for example, a reel indication frame). When a color information of a gear transmission mechanism is a wooden gear train, a gear transmission mechanism has the shape information (for example, lateral gear shape, lengthwise gear shape) of two or more gear trains.

By the way, a transparent sheet or each belt-like data A1, B1, and C1 are combined with a prescribed area of a display D, for example.

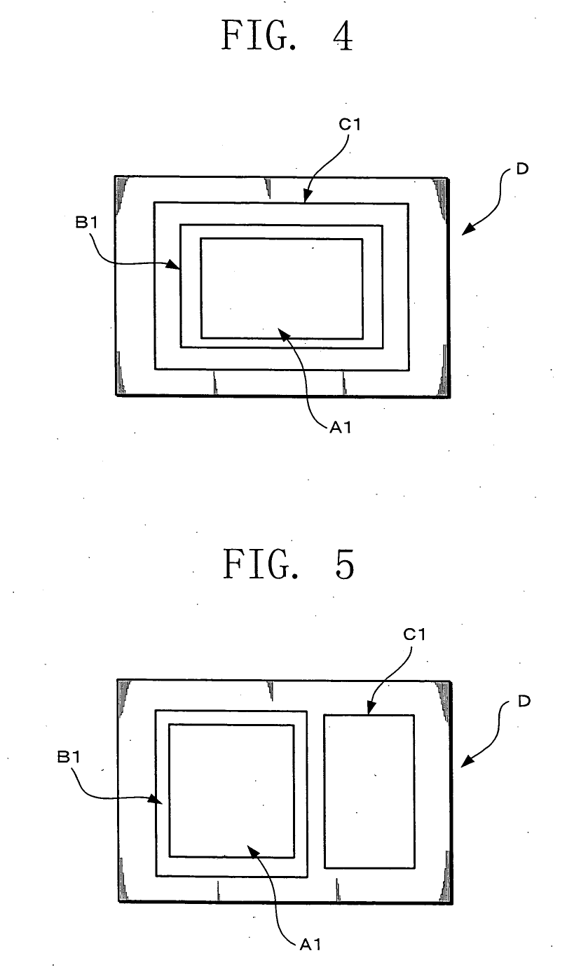

FIG. 4 is a conceptual diagram which combined each data A1, B1, and C1.

### For example, a reel data B1 is located on a background data C1, and a symbol data A1 is located on a reel data B1.

### When a game starts, each data A1, B1, and C1 are generated as related dynamically (it seems to carry out the rotary variation to the visual perception of a player).

### Of course, about combination of each data A1, B1, and C1, it does not limit to the embodiment.

As shown in FIG. 5, a symbol data A1 and a reel data B1 may be displayed on the left side of a display D.

### On the other hand, a background data C1 may be displayed on the right side of a display D.

When emphasizing a mechanical element (for example, power transmission mechanism), a portion of reel data B1 was displays on the upper side of a display D , and a data of a mechanical element also displays other portions. In addition the majority of a field is a mechanical element.

A background image C1 is generated by background image generating means 2b of image control part 2.

### A background image C1 is divided into a static image and a dynamic image.

### The 1st˜3rd background image are contained in mode of a background image, for example.

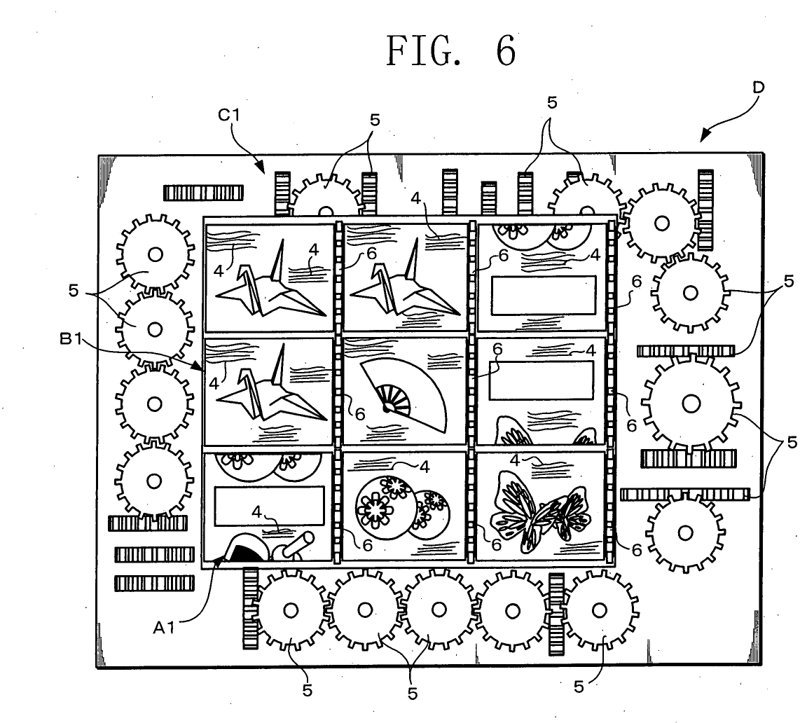

The static 1st background image shown in FIG. 6 is displayed on a display D, when all reels have stopped.

Therefore, the 1st background image appears before a game start and after end of a game. When a game is started, the 1st background image changes a display to a dynamic image.

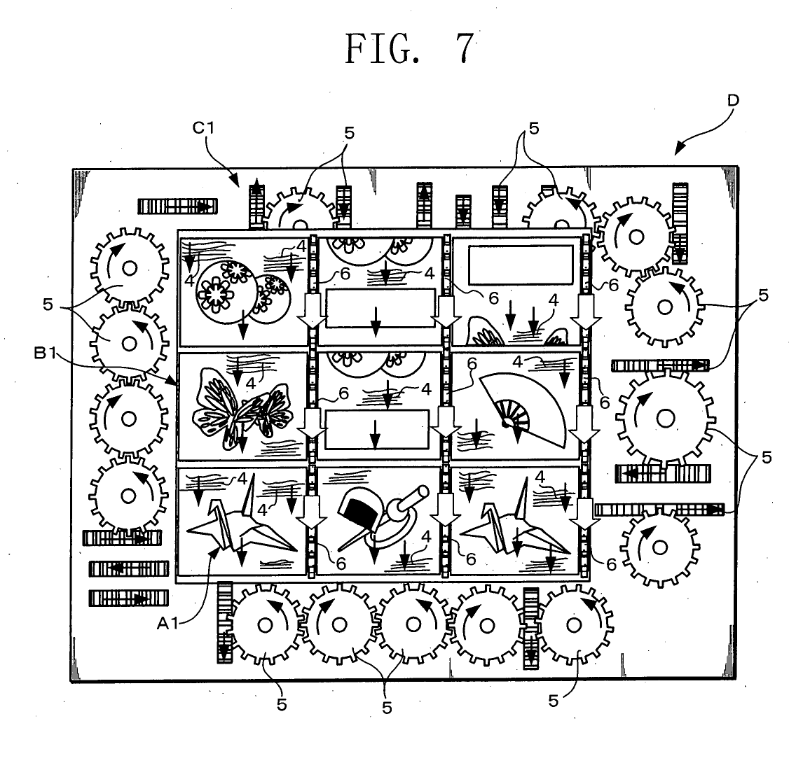

FIG. 7 is expressing giving the following images by an arrow.

### In FIG. 6, the 1st background image and a static reel image carry out variable displaying simultaneously, and all the reels are rotating actually via a the means of power transfer of a dynamic background image.

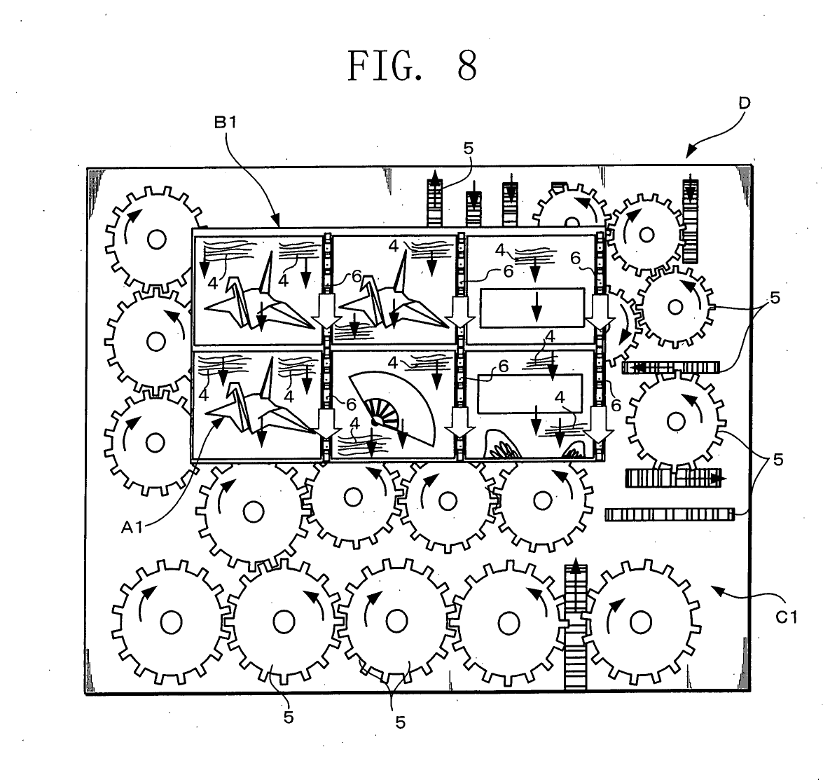

The 2nd background image shown in FIG. 8 is an example of a dynamic image.

This dynamic 2nd background image is displayed on a display D, when predetermined conditions are fulfilled in a game. As FIG. 8 showing, the dynamic 2nd background image is located the reverse side or before a reel image, and is emphasized greatly and displayed.

### In addition a reel image B1 appears in some fields of a top half of display D. On the other hand, the dynamic 2nd background image C1 appears in a field of a bottom half of Display D.

In order to emphasize the correlation between the 1st mechanical element 5 of background image C1, and the 2nd mechanical element 6 of a reel image B1, the dynamic 2nd background image C1 of this embodiment describes the dynamic reel image B1 and the dynamic 2nd background image C1 on equality, or it is describing with the majority of a field occupying by a mechanical element. As mentioned above, such image arrangement is also one mode of “Combination”.

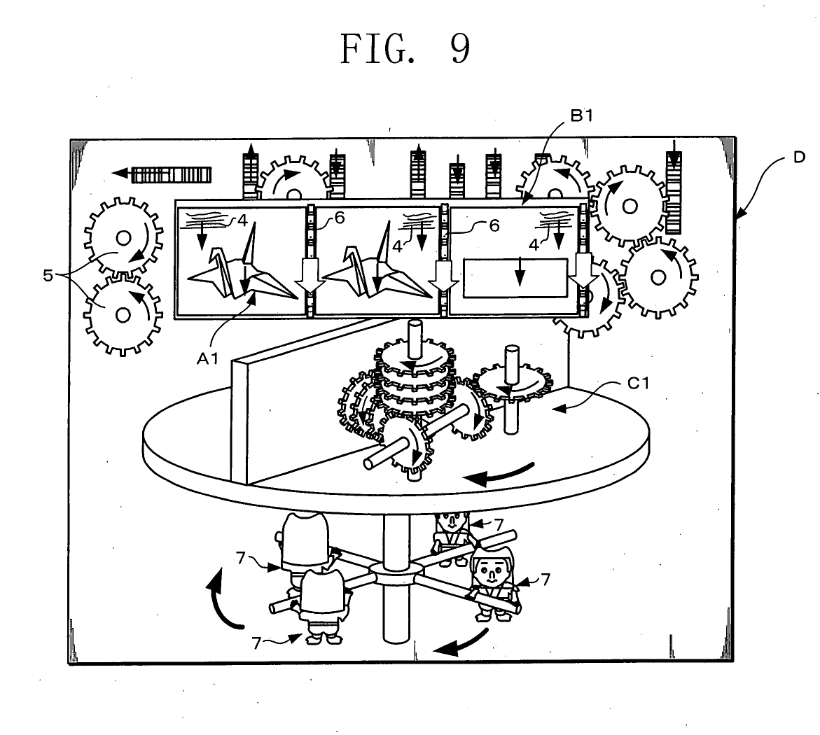

The 3rd background image C1 shown in FIG. 9 is also an example of a dynamic image. This 3rd background image C1 is displayed on display D, when predetermined conditions are fulfilled in a game. The 3rd background image is located to the front rather than a reel image. And it is emphasized and displayed so that from about 80 to 90 percent of a displays D may be occupied. The 3rd background image includes a means of power transfer 5 and a source of power 7 to which this (a means of power transfer 5) is moved (state which an a person behind the scenes is pushing).

### Thus, into a background image C1, a background image which emphasizes source of power 7 of a means of power transfer can be included.

For example, in an image which displays the state where two or more person behind the sceneses 7 (which appear as a property man in a play) are pushing a bar,

a means of power-transfer emphasizes that mechanical element 5 and 6 are moving by human power instead of an electric motor.

### A static image and a dynamic image about a reel image and a background image are tabulation, respectively.

Here, relation between input means H and storage parts store M, and a variable image is explained briefly.

In a slot machine as an example of a game machine, an input means H, such as a start lever, a the start button for reels, and a the stop button for reels, are provided, for example in a panel (common knowledge matter).

### An image control part 2 of a slot machine has storage parts store M.

In a machine only for a slot machine, after a coin injection, when a start lever or a start button is operated, or when shifting to a bonus game again, a reel image is also changed simultaneously with a background image.

### In a pachinko machine which has a slot machine on a part of a display windows, when predetermined conditions are fulfilled (for example, when a pachinko ball passes through a start gate), a reel image is changed simultaneously with a background image.

When predetermined conditions are fulfilled in a game, this 1st background image switches to the dynamic 2nd background image which emphasizes the correlation of a mechanical element.

### For example, the dynamic 2nd background image appears temporarily in the state of rotation.

When changing to the 3rd background image from the 1 st background image, or when changing to the 3rd background image from the 2nd background image, they change based on a sequence program of storage parts store M into a game.

### A static image of the 1 st background image appears again in Display D, when all the reels stop.

A reel control information generating means (correctly control information generating means of a reel state) 1 has the following functions.

### For example, when a start button of an input means H is pushed, it determines whether to display which number or pattern and to stop each Reel finally, via a sequence program of the storage parts store.

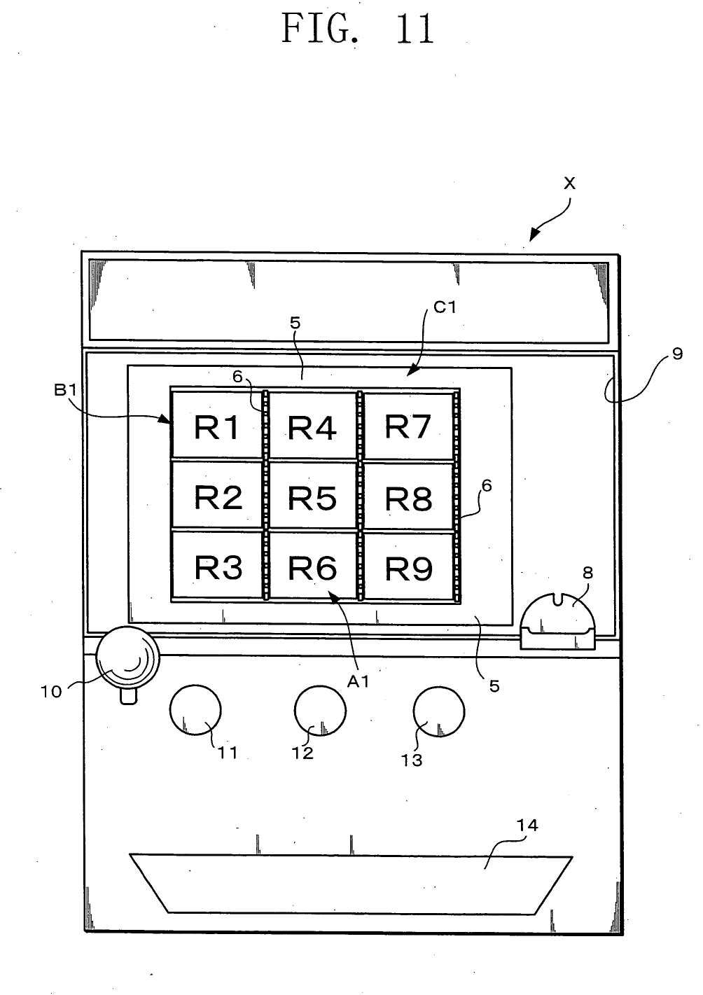

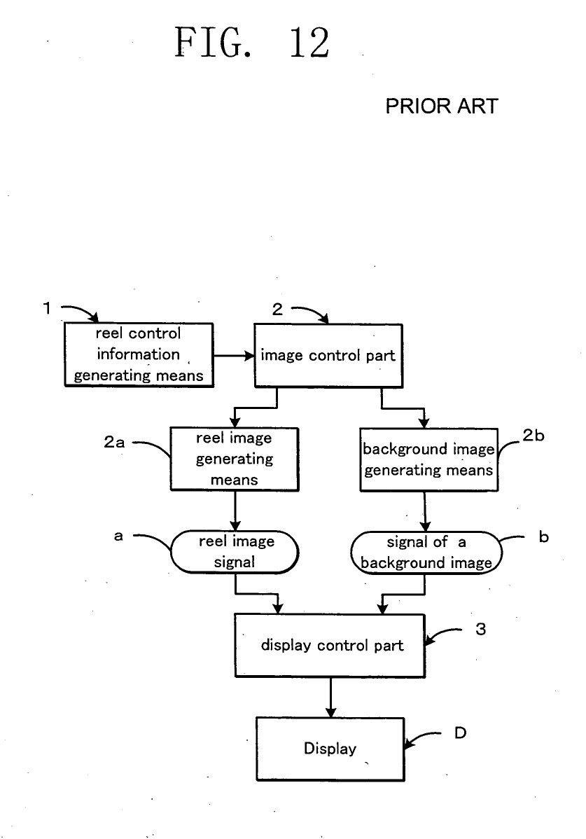

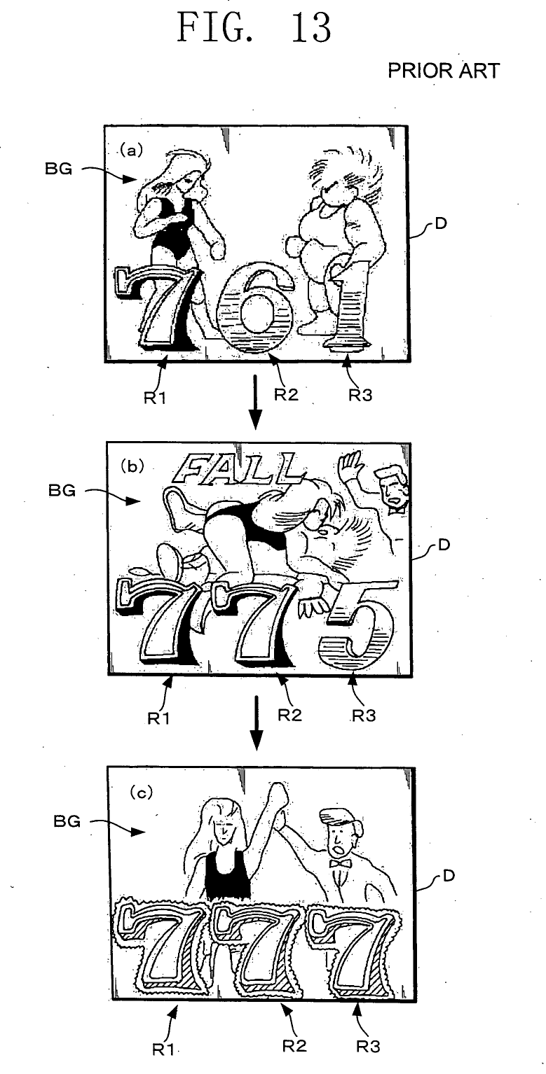

Two or more reels R1˜R9 (refer to FIG. 11) are rotated, and a random number generation means is used, a command for carrying out the stop operation of the reel image is sent one by one, for example sequentially from a left side 1st reel R1.

### In this embodiment, a reel R9 of the right side bottom stops at the end.

Here, with reference to FIG. 11, appearance composition of display type slot machine X is explained briefly.

8 is a coin slot, 9 is a display window, C1 is a background image, B1 is a reel image, R1˜R9 are two or more reels, 10 is a start lever, 11,12,13 are two or more stop buttons, 14 is a coin saucer. A matter of other common knowledge is omitted.

As FIG. 1 shows an image control part 2 has a reel image generating means 2a which carries out variable displaying of reels R1˜R9 containing a symbol A1 based on an information from a reel control information generating means 1 and, a background image generating means 2b which relates with variable displaying of a reel and carries out variable displaying of the background image C1.

Based on a command of an image control part 2, a reel image generating means 2a generates the following a reel stopped state and a reel variable displaying state, for example;

an image generating at the time of a stop of all the reels R1˜R9,
a dynamic image generating when rotating simultaneously all the reels R1˜R9,
an image generating which shows stop operation of the 1st reel R1,
an image generating which shows stop operation of the 2nd reel R2,
an image generating which shows stop operation of the last reel R9.

On the other hand, based on a command of image control part 2, a background image generating means 2b generates a background image corresponding to the following a reel stopped states and a reel change state, for example;

a generating of a background image at the time of all the reel stops,
a generating of a background image under reel change,
a generating of an emphasis background image when fulfilling predetermined conditions (from a start to for example, progress during 5 seconds),
a generating of a background image when all the reels R1˜R9 stop.

A display control part 3 is displayed on a display D combining a reel image signal “a” from an image control part 2, and the signal of a background image b.

### A combination form of an image displayed on a prescribed area of a display D is parallel duplication-like, and is not limited in particular.

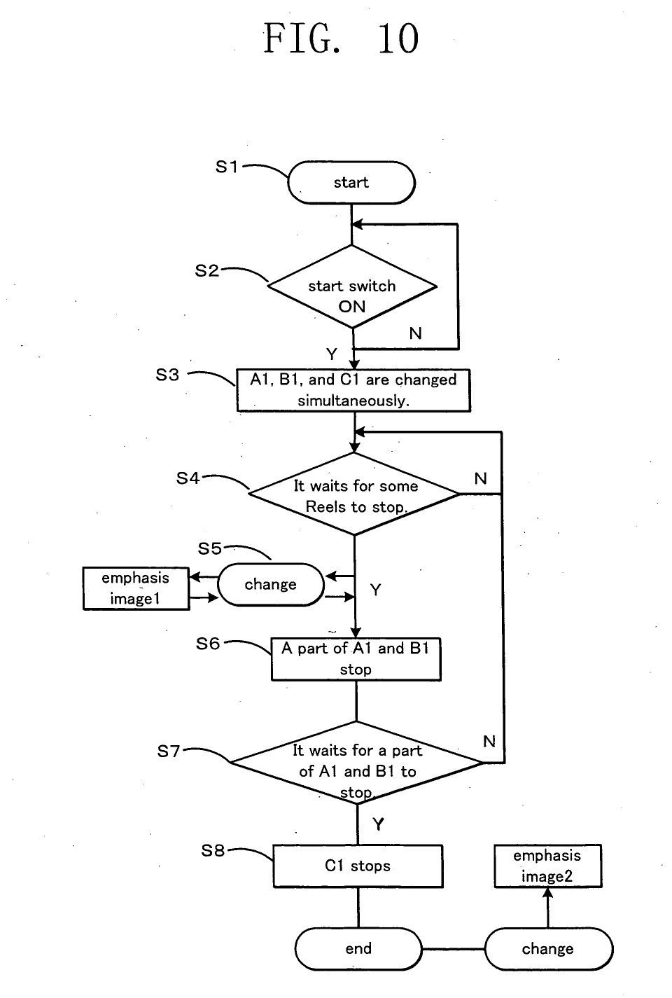

FIG. 10 is a flow chart which shows an example of the present invention.

### Two or more reels (for example, nine pieces) containing a symbol for a rotary variation display are displayed on a prescribed area of a display D.

### A partial background images which describe a gear transmission mechanism on a background (back side) of a reel image are displayed around reels.

### In an initial position, both a reel image and a background image are standing still.

Step 1 is a start. In this embodiment, for example, it starts with a start signal of a bonus game. Step 2, a start switch is “ON”.

In this game start time, by using a random number generation device, a reel control information generating means determines whether to display which number or figure finally and to stop each reel, and transmits this information to an image control part.

When image control part 2 acquires a start signal “rotate all the reels” via a generating means 1 of a reel control information from input means H or a storage parts store M, an image control part 2 displays the 1st background image dynamically, and it carries out variable displaying of all the reels (step 3).

In step 3, a reel image generating means 2a of image control part 2 generates a image signal showing the state where nine reels are rotating,

### On the other hand, a background image generating means 2b is related with this state, and generates a dynamic the signal of a background image.

In this embodiment, a background image generating means 2b is generated so that a three dimensional image which contains a 1st mechanical element 5 in a background image C1 may be displayed.

On the other hand, a reel image generating means 2a contains a 2nd mechanical element 6 at the end of a reel, and generates so that this 2nd mechanical element 6 may carry out variable displaying receiving power of a 1st mechanical element 5 of said background image.

An image control part 2 waits for indication signals, such as a stop signal acquisition of 1st reel R1, several seconds after. That is, an image control part 2 is waiting for timing which stops some reels (step 4).

In step 5, second progress were fulfilled, a display control part 3 is changed from the 1st dynamic background image to the 2nd dynamic background image receiving a command from image control part 2 (Emphasis image 1 of FIG. 8).

### A change of this background image is described by rotary system, for example.

### Shortly after the 2nd dynamic background image is temporarily displayed on a display D, it returns to the first dynamic display image.

In step 6, the 1st reel is stopped, for example.

### A command of control information generating means 1 of a reel to image control part 2 usually transmits information that the 1st, 2nd, and 3rd reels are stopped one by one, like a common slot machine.

In step 7, an image control part 2 is waiting for timing which stops all reels.

An image control part 2 does not make the 2nd dynamic background image a stop state, unless information “stop all reels” is acquired.

### In addition an image control part 2 does not stop a background image C1, unless final reel image signal “a” and the signal of a background image “b” are acquired from control information generating means 1 of a reel.

So, in step 8, image control part 2 acquires all reel stop signals from a generating means of reel control information simultaneously with a background image stop signal.

### As a stop signal was acquired from said image control part 2,

a display control part 3 displays simultaneously images of stop states of reel image B1 and a background image C1 on a specific region of a display D combining a reel image signal “a” and the signal of a background image “b”.

Of course in the above-mentioned flow chart, it may change from the 1st dynamic background image to the 3rd dynamic background image (emphasis image 2 of FIG. 9).

### The dynamic 3rd background image may be described at the time of an “end” of step 9. Therefore, about depiction time of the 2nd dynamic background image and the 3rd background image, it can set up suitably.

### EXAMPLE

In an embodiment shown by an embodiment of the present invention, it is explained that a background image generating means 2b relates with variable displaying of a reel, and carries out variable displaying of the background image C1.

### This description is the same meaning as “a reel image generating means 2a relates a background image C1 with variable displaying and a reel carries out variable displaying.”

In this embodiment,

(a) A variable displaying of a reel displayed on a display gives mechanical element 6, and pattern elements 4 other than a symbol are added.

### However, in a relation with the intended object of the present invention, following any may be sufficient. (Refer to FIG. 2 and FIG. 8).

(b) When only mechanical element 6 is given to variable displaying of a reel displayed on a display,
(c) When only pattern element 4 is given to variable displaying of a reel displayed on a display. A gear transmission mechanism as an example of a power transmission mechanism of a background image C1 was shown.

However, this is only an example. For example, as a mechanical element of a background image C1, machine elements, such as a “belt and pulley”, a “linkage”, a “rack and pinion” etc. can be listed. A variable setup is possible for a form of a reel image, and a form of a background image. Of course, the number of reels can also be set up freely. Each meaning of a background image, a reel image, and a symbol is interpreted using the knowledge of one skilled in the art.

Game machines, such as a pachinko machine, are also contained in a display type slot machine (for example, it is incorporable as a functional component of a pachinko machine).

As set forth above, the advantages of the invention are as follows:

(1) In a display type slot machine, when a game is started, for the visual perception of a player, a mechanical and a three-dimensional real feeling, or a pattern element can be given to variable displaying of a reel displayed on a display, and an image which a reel rotates actually via the means of power transfer of a background image can be given.

### (2) When a part or all of a means of power transfer of a background image is described greatly, the correlation of a mechanical element of a background image and a mechanical element (or pattern element of a reel) of a reel image can be emphasized.

### (3) Depending on the contents of the background image, the source of power of a means of power transfer can be emphasized.

For example, by a image which displays the state where two or more persons behind the sceneses (a property man) are pushing a bar, the means of power transfer can emphasize not an electric motor but a purport that a mechanical element is moving by human power. Of course, electromotive power, nature power, etc. may be sufficient as the source of power.

The foregoing relates to a preferred exemplary embodiment of the invention, it being understood that other variants and embodiments thereof are possible within the spirit and scope of the invention, the latter being defined by the appended claims.

1-9. (canceled)

10. In a display type slot machine assembly having
a control information signal generating means of a reel state which generates a rotary variation information signal of a reel and a stop information signal of a reel based on information signals of a storage parts store, an image control part which has a reel image generating means which carries out variable displaying of the reel which contains a symbol based on information signals from said control information signal generating means and a background image generating means which relates with variable displaying of a reel and carries out variable displaying of the background image and
a display control part displayed on a display combining a reel image signal and a signal of a background image from said image control part, the improvement wherein
said background image generating means is operable to produce a three dimensional image which contains a 1st mechanical element in said background image which may be displayed and said reel image generating means contains a 2nd mechanical element in an end display of said reel, said 2nd mechanical element being operable to carry out variable displaying in response to power of a 1st mechanical element of said background image.

11. The display type slot machine according to claim 10, wherein said a 1st mechanical element of said background image imitates a power transmission mechanism.

12. The display type slot machine according to claim 10, wherein said 1st mechanical element of said background image is displayed on the peripheral area of two or more reels.

13. The display type slot machine according to claim 10, wherein a data of a reel pattern displayed on a field of a reel is contained in reel data for said reel image generating means stored in said storage parts store.

14. The display type slot machine according to claim 10, wherein said display is displayed so that it may have a background image viewing area,
two or more reel viewing areas displayed so that it may overlap with said background image viewing area and
two or more symbol display fields displayed so that it may overlap with said reel viewing area,
said reel viewing area being displayed so that a reel pattern separate from a symbol may carry out a rotation variation.

15. The display type slot machine according to claim 10, wherein a dynamic background image contains at least one emphasis image, and a viewing area of said 1st mechanical element of this emphasis image is larger than a viewing area of said 1st mechanical element of a static background image.

16. The display type slot machine according to claim 10, wherein an image which emphasizes the source of power of said 1st mechanical element is contained in said dynamic background image.

17. The display type slot machine according to claim 10, wherein said 1st mechanical element of said background image imitates a gear transmission mechanism.

18. In a display type slot machine assembly having
a control information signal generating means of a reel state which generates a rotary variation information signal of a reel and a stop information signal of a reel based on information signal of a storage parts store, an image control part which has a reel image generating means which carries out variable displaying of the reel which contains a symbol based on information signals from said control information signal generating means and a background image generating means which relates with variable displaying of a reel and carries out variable displaying of the background image and
a display control part displayed on a display combining a reel image signal and a signal of a background image from said image control part, the improvement wherein
said background image generating means is operable to produce a three dimensional image which contains said mechanical element in said background image which may be displayed and said reel image generating means is operable to produce a pattern element which may be included in said reel, and wherein this pattern element may carry out variable displaying to said reel in response to power of a mechanical element of said background image.
